(19) United States
(12) Patent Application Publication
(10) Pub. No.: US 2008/0131133 A1
(43) Pub. Date: Jun. 5, 2008

(54) LOW SINR BACKSCATTER COMMUNICATIONS SYSTEM AND METHOD

(76) Inventors: Shannon D. Blunt, Shawnee, KS (US); Daniel D. Deavours, Lawrence, KS (US); Ronald M. Barrett-Gonzalez, Lawrence, KS (US); Christopher T. Allen, Lawrence, KS (US)

Correspondence Address: SCHWEGMAN, LUNDBERG & WOESSNER, P.A., P.O. BOX 2938, MINNEAPOLIS, MN, 55402, US

(21) Appl. No.: 11/750,080

(22) Filed: May 17, 2007

Related U.S. Application Data
(60) Provisional application No. 60/801,165, filed on May 17, 2006.

(51) Int. Cl. H04B 10/00

(52) U.S. Cl. 398/128

(57) ABSTRACT

A method and system for a device to embed a low signal to interference plus noise ratio (SINR) communications signal into the backscatter of an illuminating signal. The illuminating signal may be acoustic or electromagnetic (EM) such as radio frequency (RF), light, or infrared (IR). The embedded communications signal may be recovered at a desired receiver.

### RELATED APPLICATIONS

This application is based upon, and claims priority to, previously filed provisional application Ser. No. 60/801,165 filed on May 17, 2006. The provisional application is hereby incorporated by reference.

### FIELD OF THE INVENTION

This invention relates to processing communication signals. More specifically, it relates to backscatter communications.

### BACKGROUND

Active illumination is ubiquitously employed for active sensing applications such as surveillance/search, tracking, mapping, etc as well as for communications. In general, an illuminating signal (which may be EM or acoustic) is used to either convey a communications signal or to obtain reflections from objects within the illuminated environment thereby providing information such as range, radial velocity, chemical composition, target images, etc. The illuminating signal is typically modulated in terms of either center frequency (Frequency-Shift-Keying or Frequency-Hopping CDMA), phase (such as FM, Phase-Shift-Keying, or Direct-Sequence CDMA), amplitude (AM), polarization (usually On-Off-Keying), or time (e.g. Pulse Position Modulation), or some combination thereof with the unmodulated characteristics remaining constant. In a general sense, the combined set of modulations that are encoded into the illuminating signal as well as the constant characteristics can be concisely represented as the illuminating waveform. The illuminating waveform may have finite temporal extent with an obvious beginning and end, such as the case for time-division communication systems or a pulse used in sensing applications, or may be “always on”, such as with some frequency-division and code-division communications systems. In the latter case, the illuminating waveform can be taken as an appropriate finite duration portion of the taken as an appropriate finite duration portion of the illuminating signal, with a collection of P consecutive illuminating waveforms denoted as the illumination frame.

Related art to the present subject matter is that of Radio Frequency Identification (RFID) technology whereby an interrogator transmits a signal which is received by a passive device which then reflects the incident energy while modulating additional information onto the incident signal. This process, which is also known as “backscatter communications” has application to inventory control or could be employed to determine the status of a sensor (or sensors) from some distance away. In both cases, a significant benefit of RFID technology is that the passive device need not supply its own power for the modulated backscatter signal that is reflected back to the interrogator. As such, the internal power requirements of the device are very small or may even be zero. In general, RFID technology is used as a means to communicate with a relatively high SINR in order to maximize the data throughput. Some related art incorporated herein by reference includes U.S. Pat. Nos. 6,600,905; 6,615,074; 6,456,668; 6,084,530; 6,459,726; 6,970,089 B2; and 6,443,671 B1; and R. Bracht, E. K. Miller, and T. Kuckertz, “An Impedance-Modulated-Reflector System,” IEEE Potentials, October/November 1999, pp. 29-33.

Other related art included herein by reference include U.S. Pat. No. 6,577,266 B1, U.S. Pat. No. 5,767,802, and U.S. Pat. No. 5,486,830 in which, for the specific application to synthetic aperture radar (SAR) a phase modulation is applied on an inter-pulse basis to enable location/communication information to be transmitted to the illuminating SAR by an active RF transponder. This idea has been further extended to intra-pulse (i.e. waveform level) modulation for SAR specifically using Linear Frequency Modulation (LFM) in U.S. Pat. No. 6,791,489 B1 and U.S. Pat. No. 5,821,895, incorporated by reference. In addition, a communication transponder employing a simple up- or down-conversion in frequency within the operating bandwidth of a radar illuminator is illustrated in U.S. Pat. No. 6,081,222, incorporated by reference. Other related art incorporated by reference includes U.S. Pat. No. 6,925,133 and G. L. Stüber, Principles of Mobile Communication, Kluwer Academic Publishers, Boston, 2001, pp. 172-175, that describe employing orthogonal modulation whereby M orthogonal codes are simultaneously transmitted with each being individually coded with information.

### BRIEF DESCRIPTION OF THE DRAWINGS

FIG. 1 illustrates an exemplary communications system.

FIG. 2 is a flow diagram illustrating a method for low SINR communications.

FIG. 3 is a block diagram illustrating embedding low SINR communication signals.

FIG. 4 is a block diagram illustrating extraction of the low SINR communication signals.

FIG. 5 illustrates an incident signal at an intended receiver over a frame.

FIG. 6 illustrates an integrated power from all possible combinations of alternative waveforms.

FIG. 7 illustrates integrated power from allowed combinations of alternative waveforms.

FIG. 8 is a block diagram of an exemplary BCD.

FIG. 9 is a block diagram of an exemplary illumination source.

### DETAILED DESCRIPTION

The present subject matter relates to a means for a device to embed a low signal to interference plus noise ratio (SINR) communications signal into the backscatter of an illuminating signal, which could be acoustic or electromagnetic (EM) such as radio frequency (RF), light, or infrared (IR), to be recovered at a desired receiver. The device communicates by re-modulating in terms of phase and/or amplitude the illuminating signal (or waveform) incident at the device into that of one of a finite set of alternative waveforms (the communication symbols) using one of a prescribed set of re-modulation schemes as well as applying a particular scalar phase shift, frequency up/down-conversion, delay shift, and polarization (for EM but not for acoustic), each of which may take on one of a finite set of possible values. Over a set of consecutive waveforms a particular sequence of scalar phase-shifts, frequency shifts, delay shifts, and polarizations is denoted as a particular frame coding scheme. For each frame coding scheme in use, coherent processing is performed at the intended receiver over the set of all the possible combinations of consecutive alternative waveforms. The information embedded by the device is then recovered by determining which of the coherently processed outputs contains the most sufficiently detectable value using a standard detector. In addition, multiple frame coding schemes may be employed simultaneously in order to maximize the throughput of the embedded information given the constraint on available illuminating energy and the desired/necessary level for sufficient detection after coherent integration. A communications system as described herein is applicable to low SINR communications in which it is either desired or necessary that coherent integration be employed to extract the signal from noise. For example, such a system may be employed for deep space communication back to earth using sunlight as the illuminating signal of opportunity or as a means of maintaining a secure communication link.

Conceptually, any illuminating signal of opportunity can be used to embed a communications signal. In an exemplary system as described herein, each illuminating waveform of the signal of opportunity is intra-modulated into one of a pre-determined number of alternative waveforms (the communication symbols) and also scalar phase-shifted (constant over the waveform), center frequency shifted, time delay shifted, and polarization shifted each according to an inter-modulation frame coding scheme over the P consecutive waveforms within the illumination frame. The frame coding scheme acts as an identifier such that either multiple backscatter devices may simultaneously embed communication signals or a single backscatter device may embed multiple communication signals in parallel (given sufficient illuminated energy). At the intended recipient, for each known frame coding scheme coherent integration is performed by matched filtering and combining the P received signals using all possible combinations of consecutive alternative waveforms followed by a standard detector. Detection of a significant signal indicates the reception of a particular sequence of alternative waveforms and, as such, an associated set of encoded information (e.g. a binary sequence).

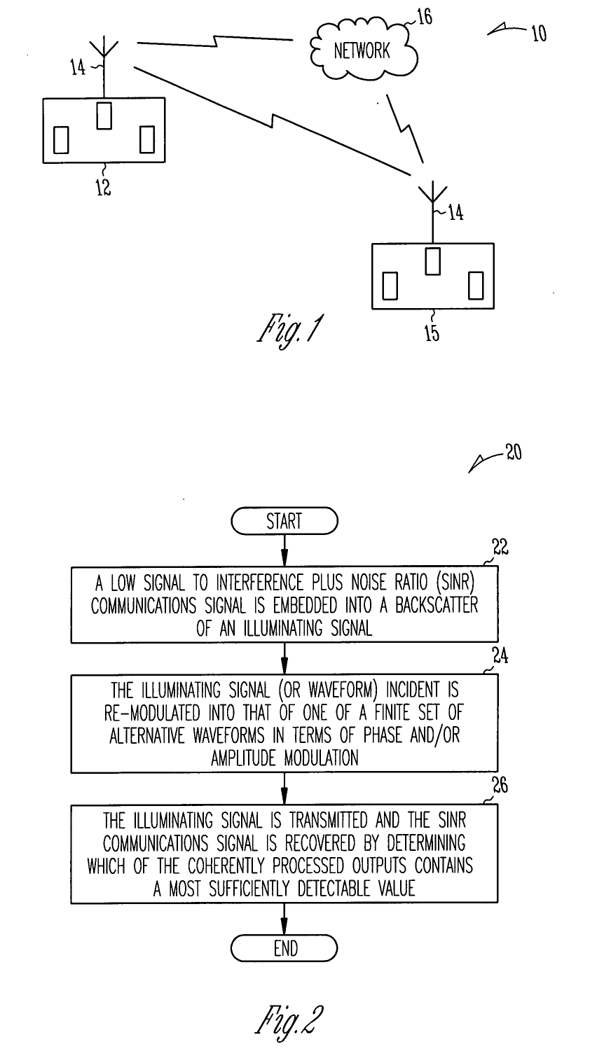

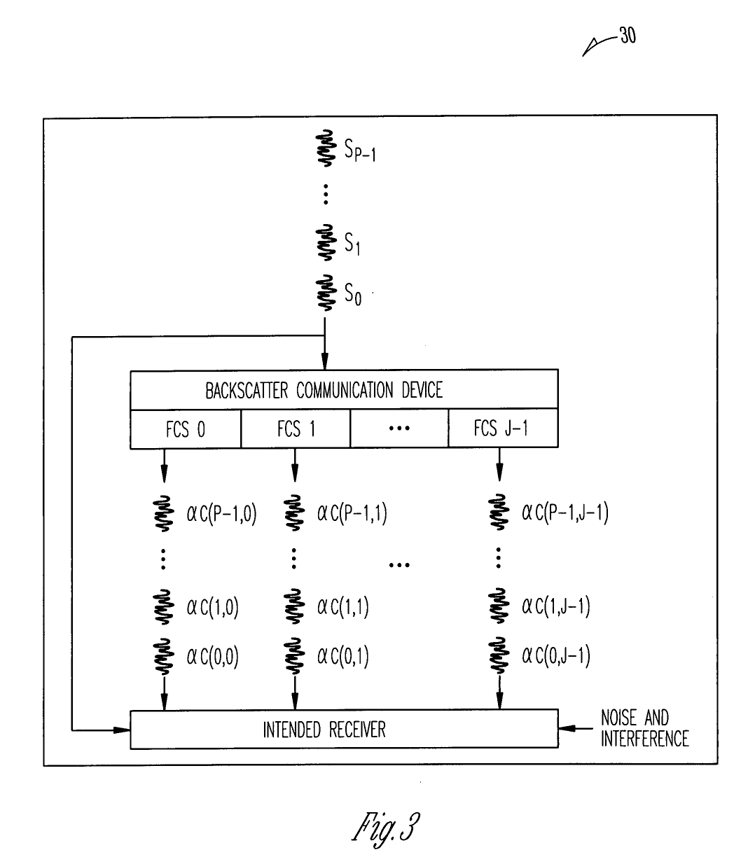

FIG. 1 is a block diagram of an exemplary communications system 10 including plural devices 12 and 15 with transceivers (two of which are illustrated), antenna 14, and a communication network 16. FIG. 2 is a flow diagram illustrating a Method 20 for low SINR communications. At Step 22, a low signal to interference plus noise ratio (SINR) communications signal is embedded into a backscatter of an illuminating signal. The illuminating signal includes acoustic or electromagnetic (EM) such as radio frequency (RF), light, or infrared (IR), to be recovered at a desired receiver. At Step 24, the device 12 communicates with the communications network 16 by re-modulating in terms of phase and/or amplitude the illuminating signal (or waveform) incident at the device 12 into that of one of a finite set of alternative waveforms (the communication symbols) using one of a prescribed set of re-modulation schemes as well as applying a particular scalar phase shift, frequency up/down-conversion, delay shift, and polarization (for EM but not for acoustic illumination), each of which may take on one of a finite set of possible values. At Step 26, the illuminated signal is transmitted by the device 12 and the SINR is then recovered by another device 15 by determining which of the coherently processed outputs contains the most sufficiently detectable value using a standard detector. In addition, multiple frame coding schemes may be employed simultaneously in order to maximize the throughput of the embedded information given the constraint on available illuminating energy and the desired/necessary level for sufficient detection after coherent integration.

### Exemplary Operational Description

A system as described herein may embed a communications signal into an illuminating signal that consists of a set of P illuminating waveforms (denoted as the illumination frame) which may be either a set of a pulses or segments of a continual signal. In either case, the system performs in effectively the same way with the latter case also requiring the intended communication recipient to synchronize with the backscatter communication device. The illuminating signal may be an electromagnetic (EM) or acoustic signal, and the system employs some form of modulation in terms of phase, frequency (frequency shift keying or FM) and/or amplitude (AM) with some given bandwidth at a particular operating frequency and with some given polarization. In the following descriptions of the mathematical operations according to one specific embodiment, discrete notation is used in order to compactly represent the mathematical operations in the backscatter communications device and the intended receiver. However, it should be noted that the same general procedures hold for analog processing as well.

A discrete-time (sampled) version of the p^{th} illuminating waveform is denoted as the column vector sₚ having length L. It is assumed that the backscatter communication device (BCD) is appropriate for the particular illuminating signal (i.e. RF, optical, infrared, or acoustic) and is capable of modulating the phase and/or amplitude of the illuminating waveform as well as altering its operating frequency, polarization, and/or time delay. As such, the BCD is capable of producing a pre-determined number of phase and/or amplitude shifts over the extent of the illuminating waveform thereby re-modulating it into one of K alternative waveforms (the communication symbols), each of which may occupy any one of F up/down-converted operating frequencies with any one of M different scalar phase-shifts and with any one of R polarizations at any one of N possible time delays. It is further assumed that the BCD is capable of phase and/or amplitude modulation at a sufficiently high rate so that the resulting set of alternative waveforms achieves a sufficient degree of decorrelation with the illuminating waveform. As such, using the K waveform intra-modulation schemes Φ₁, . . . , Φ_{K-1}, the device converts the illuminating waveform sₚ into one of a predetermined set of K alternative waveforms denoted as cₖ(p) for k=0, 1, . . . , K−1. The m^{th} scalar phase-shift for m=0, 1, . . . , M−1 is denoted by the factor bₘ.

For each illuminating waveform, the BCD embeds one of the K possible alternative waveforms with one of the M scalar phase-shifts into a particular frequency (of F), polarization (of R), and time delay (of N) according to the particular frame coding scheme (FCS). Note that if the successive illuminating waveforms s₀, s₁, . . . , s_{P-1} are different (such as can be expected for an illuminating communications signal) this will result in a different set of possible alternative waveforms cₖ(p)=Φₖ{sₚ} with k=0, 1, . . . , K−1 for each illuminating waveform. Intra-waveform modulation in this manner enables the BCD to be much less sophisticated as it does not need to determine the exact illuminating waveform but simply operate upon it. However, the intended receiver also has access to the illuminating signal to use as a reference in order to generate the set of possible alternative waveforms with which coherently process the received signal via matched filtering.

As an example, consider the simple case in which P=4 illuminating waveforms constituting the illumination frame whereby the possible FCSs consist of M=8 possible scalar phase shifts, F=4 possible frequency shifts, R=4 possible polarizations, and N=6 possible delay shifts. A particular hypothetical FCS could then be described by Table 1. Hence, for the p=2 illuminating waveform, one of the K possible alternative waveforms is embedded with the m=7 scalar phase shift, the f=2 frequency shift, the r=3 polarization, and the n=4 delay shift. As a result, the information embedded over the course of the illumination frame is provided a degree of security according to the number of possible FCSs and possible alternative waveform combinations. Furthermore, the FCSs offer a degree of robustness to noise and interference by providing frequency and polarization diversity. Note that, as in the example for the delay shift of p=0 and p=2, the FCS characteristics may repeat or even be constant over the illumination frame.

TABLE 1
Hypothetical frame coding scheme

Illum. waveform
index (P = 4)

| | 0 | 1 | 2 | 3 |
|---|---|---|---|---|
| Phase shift | 3 | 6 | 7 | 4 |
| index (M = 8) | | | | |
| Frequency | 1 | 3 | 2 | 0 |
| shift index | | | | |
| (F = 4) | | | | |
| Polarization | 0 | 1 | 3 | 2 |
| index (R = 4) | | | | |
| Delay shift | 4 | 0 | 4 | 5 |
| index | | | | |
| (N = 6) | | | | |

In general, over the p^{th} receive interval (which constitutes the time frame over which the N possible delay shifts of the p^{th} embedded alternative waveform are incident at the intended receiver), after frequency down-conversion of the f^{th} operating frequency with the r^{th} polarization (it can be assumed that the intended recipient has knowledge of what these are for a particular FCS), a received signal vector y_{p,f,r} is obtained which has sufficient length to contain an embedded alternative waveform of length L for the particular delay shift associated with the p^{th} waveform of the FCS. A general model for the received signal, given the possible presence of any one of the K alternative waveforms along with the m^{th} scalar phase-shift (according to the particular FCS) and noise and interference, can be expressed at the n^{th} delay sample of y_{p,f,r} as

$${y}_{p , m , f , r} ( n ) = {\sum }_{k = 0}^{K - 1} {b}_{m} {z}_{k}^{T} ( p , m , f , r , n ) {c}_{k} ( p ) + v ( n ) \qquad ( 1 )$$

where v(n) is additive noise and interference (which could include the illuminating waveform) and (•)^{T} is the transpose operation. For the l^{th} alternative waveform cₗ(p) being the embedded communication symbol, the first element of the L-length vector zₗ(p,m,f,r,n)=[zₗ(p,m,f,r,n) zₗ(p,m,f,r,n−1) . . . zₗ(p,m,f,r,n−L+1)]^{T}, which we denote as a communication profile, will contain a single relatively small, real positive value α and will otherwise possess zeros as will the other vectors zₖ(p,m,f,r,n) for k=0, 1, . . . , K−1 with k≠l.

The collection of the n^{th} delay sample along with the following L−1 contiguous samples of the received signal in (1) can be expressed as

$${y}_{p , m , f , r} ( n ) = {\sum }_{k = 0}^{K - 1} {b}_{m} {Z}_{k}^{T} ( p , m , f , r , n ) {c}_{k} ( p ) + v ( n ) \qquad ( 2 )$$

where y_{p,m,f,r}(n)=[y_{p,m,f,r}(n) y_{p,m,f,r}(n+1) . . . y_{p,m,f,r}(n+L−1)]^{T} is a vector of the received signal samples, zₖ(p,m,f,r,n)=[zₖ(p,m,f,r,n) zₖ(p,m,f,r,n+1) . . . zₖ(p,m,f,r,n+L−1)] is a matrix of delay-shifted versions of the k^{th} communication profile, and v(n)=[v(n) v(n+1) . . . v(n+L−1)]^{T} is a vector of noise and interference samples. Coherent integration at the p^{th} receive interval is performed for each of the K alternative waveforms by applying the matched filter [3] to the received signal vector in (2) along with complex conjugate of the particular scalar phase shift as

\hat{z}ₖ(p,m,f,r,n)=b*ₘcₖ^{H}(p)y_{p,m,f,r}(n). (3)

where (•)^{H} is the complex-conjugate transpose (or Hermitian) operation. According to the FCS over the P waveforms, the appropriate \hat{z}ₖ(p,m,f,r,n) values are summed for all of the K^{P} possible combinations of P consecutive alternative waveforms resulting in K^{P} output values. A standard detector is then applied to the output values from which the largest detectable value (of which there could be none) is determined to be the particular embedded communication signal thereby conveying a maximum of P log₂ K bits. Also, some number J of the possible FCSs may be used simultaneously such that the total maximum information is J P log₂ K bits. In addition, if each of the J frame coding schemes could take on one of a set of Q possibilities (assuming little similarity among any of the JQ frame coding schemes to minimize correlation and relatively homogeneous noise and interference among each set of Q), then a maximum of J(P log₂ K+log₂ Q) bits of information are conveyed.

In practice, the presence of noise and interference can degrade performance as a result of the possible similarity between different sets of the K^{P} possible combinations of sequential alternative waveforms. This is alleviated by restricting the allowable alternative waveform sequences to be some subset of D of the K^{P} possible combinations. As a result, instead of each FCS conveying the maximum P log₂ K bits, it would be reduced to log₂ D bits. The benefit is the inherent error correction capability as well as the additional security in that without knowledge of which alternative waveform sequences are allowed, there will appear to be numerous possibilities.

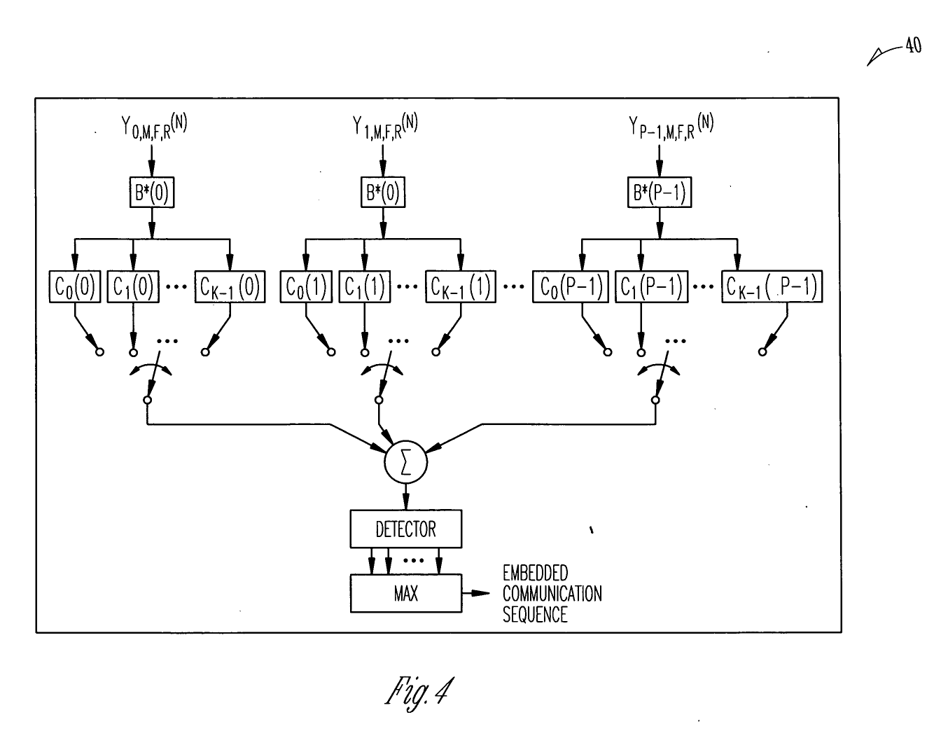

FIG. 3 depicts the operation of the BCD for simultaneously embedding different communication signals into J different frame coding schemes in which c(p,j) corresponds to the j^{th} FCS and could be any one of the K alternative waveforms that could be generated from the p^{th} illuminating waveform according to the waveform intra-modulation schemes Φ₀, . . . Φ_{K-1}.

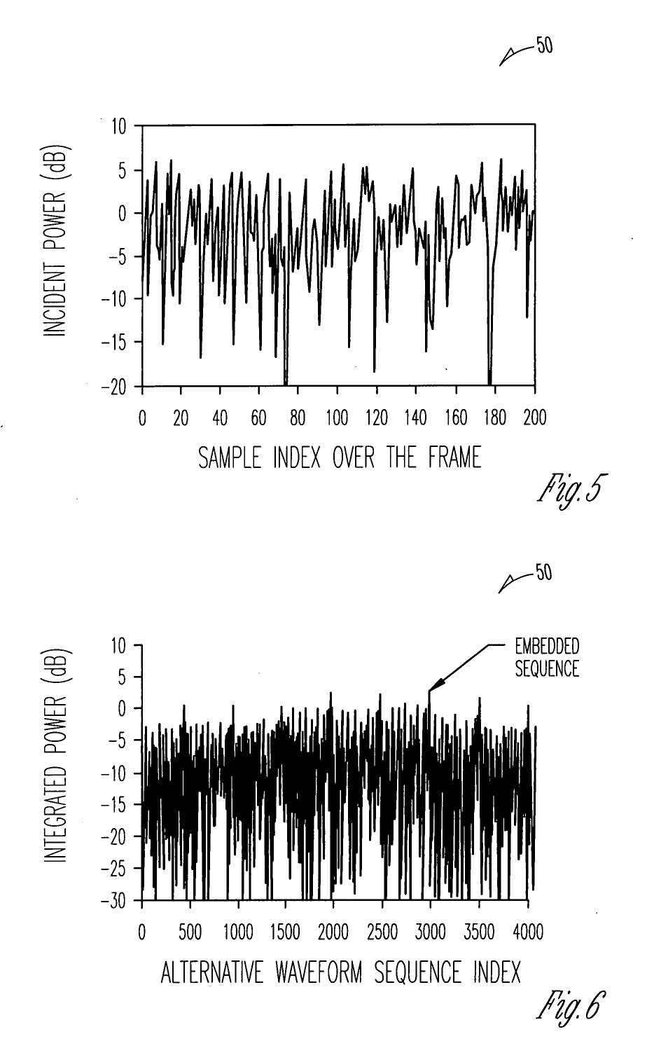

For each receive interval the intended receiver performs the appropriate frequency down-conversion to baseband with the appropriate polarization to extract the particular received signal samples corresponding to the proper delay shift according to each known FCS. FIG. 4 illustrates the subsequent processing for the j^{th} FCS which begins with the resulting baseband signal for the p^{th} receive interval being multiplied by b*(p) which is the complex conjugate of the p^{th} scalar phase shift according to the particular FCS and then matched filtered by all of the K possible alternative waveforms. These results are then combined over the D allowable combinations of P consecutive alternative waveforms from which is selected the maximum absolute value exceeding some detector threshold (determined using some standard detector, for example a constant false-alarm rate (CFAR) detector). The selected sequence is decoded to determine the information conveyed by the BCD.

### OTHER SPECIFIC EMBODIMENTS

In certain systems as described above, phase coherency is maintained over the frame and as such over the different frequency and polarization shifts. In cases where this may not be feasible or simply to reduce cost, the set of possible frame coding schemes may be reduced to include only those that maintain the same frequency shift and polarization over the P waveforms.

In a particular embodiment, the illuminating signal may be used to enable a low-rate communications “network” within a local area whereby the communications signals between devices would be masked by the illuminating signal and noise. Individual BCDs within the network could employ protocols with which they would be allocated specific frame coding schemes as well as allowable subsets of alternative waveform sequences.

In another embodiment, the system provides a means of identification validation such that the BCD embeds only one sequence which is converted according to a particular frame coding scheme and a particular combination of the alternative waveforms which is known to the intended receiver. As such, the BCD encrypts the illuminating signal which can only be decrypted if the frame coding scheme and particular alternative waveform sequence is known.

Another alternative implementation is to perform detection on the matched filter outputs from each individual receive interval. In this case, the maximum of P log₂ K bits per FCS can be obtained with the trade-off of either increasing α or L relative to the original case in order to maintain the same probability of detection. Note that in this case, the sequence of scalar phase shifts over the FCS is unnecessary since coherent integration is not performed over the entire FCS. However, the sequences of frequency shifts, polarization shifts, and delay shifts still provide diversity, security, and the ability to simultaneously embed communication signals into multiple FCSs.

As a simple demonstration, consider an illumination frame of size P=4 operating at a constant frequency shift, polarization, and delay shift over the frame with M=8 possibilities for scalar phase shifts (equally spaced on 2π) over the frame. The alternative waveforms are chosen to have L=50 samples with K=8 different alternative waveforms (randomly generated phase sequences). Hence, there are 8⁴=4096 possible combinations of consecutive alternative waveforms from which we select D=512 sequences thereby yielding log₂(512)=9 bits over the FCS. The D=512 sequences are chosen such that any two of the sequences have at most 2 alternative waveforms in common over the sequence of P=4 resulting in a maximum correlation between sequences of approximately 10 log₁₀ ( 2/4)=−3 dB.

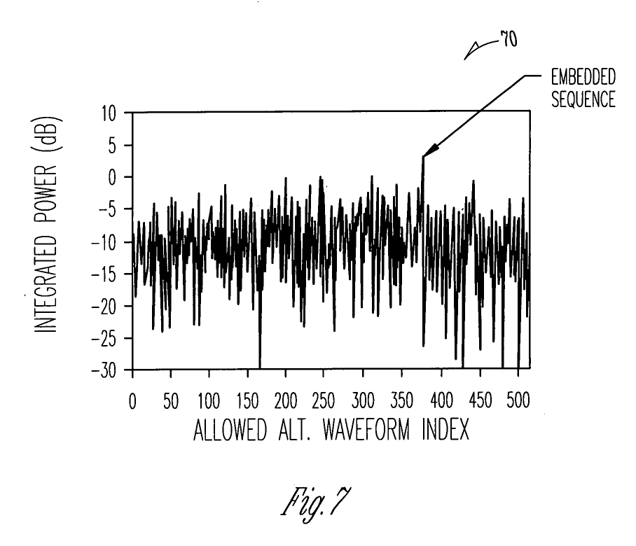

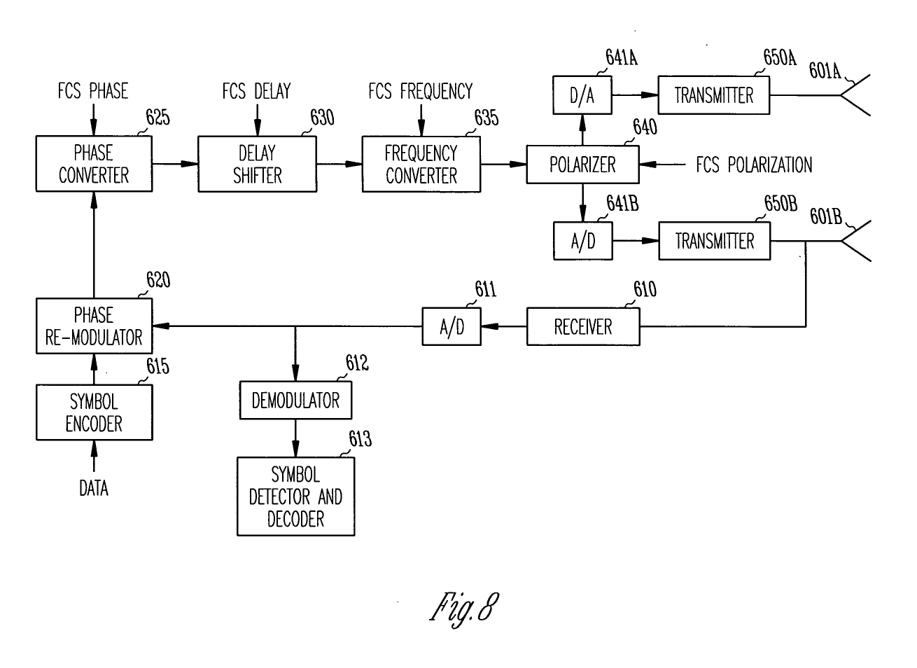

The backscatter cross-section of the device is adjusted such that the signal to interference plus noise ratio (SINR) of each sample of the embedded signal is −10 dB in which the noise and interference is modeled as additive white Gaussian. FIG. 5 depicts the incident signal at the intended receiver over the frame in which, because of its low SINR, we cannot see the constant modulus sequence of embedded alternative waveforms. Matched filtering each receive interval with the K=8 possible alternative waveforms and then coherently integrating over the frame using all possible combinations of alternative waveform sequences yields the integrated power levels as shown in FIG. 6 where we see that there appear to be several combinations that could be the embedded sequence. However, limiting this to only the allowed sequences results in FIG. 7 in which it becomes obvious which is the correct embedded sequence.

In an exemplary embodiment of the communications system described above, the system includes an illumination source configured to radiate an illuminating signal and a backscatter communication device (BCD) configured to re-modulate the illuminating signal received from the illumination source with message data. The BCD is configured to further modify the re-modulated illuminating signal so that the re-modulated illuminating waveform varies as to a plurality of frame coding parameters within defined time frames as specified by a defined frame coding scheme (FCS), where the plurality of frame coding parameters is selected from a group that includes frequency, time delay, and phase. The group of frame coding parameters may further include polarization such that the frame coding scheme (FCS) specifies a variation in polarization within each time frame, which variation in polarization is imparted by the BCD to the re-modulated illuminating signal that is re-transmitted and synchronously reversed by the illumination source or other intended recipient. The FCS may specify modifications as to frequency, time delay, and phase for each illuminating waveform within a frame. The BCD is configured to re-transmit the re-modulated illuminating signal as modified in accordance with the FCS to the illumination source or other intended recipient. The illumination source or other intended recipient is configured to receive the re-transmitted signal from the BCD, synchronously reverse the modifications made to the re-transmitted signal by the BCD according to the FCS for each received frame of the re-transmitted signal, and demodulate the re-transmitted signal to extract the message data therefrom.

In other embodiments, the BCD may be configured to re-modulate each of one or more discrete segments of the illuminating signal within each time frame, referred to as illuminating waveforms, into one of a finite set of alternative waveforms that serve as communication symbols. The illumination source or other intended recipient may be configured to synchronously detect the alternative waveforms from the re-transmitted illuminating signal by correlating the re-transmitted illuminating signal with the finite set of alternative waveforms after reversal of the FCS modifications. The illumination source or other intended recipient may be configured to synchronously detect the alternative waveforms from the re-transmitted illuminating signal by correlating each illuminating waveform of the re-transmitted illuminating signal with the finite set of alternative waveforms or by correlating each frame of the re-transmitted illuminating signal with sequences of the finite set of alternative waveforms to thereby detect a particular sequence of alternative waveforms that serve as a communications symbol. The BCD may be configured to simultaneously re-transmit a plurality of re-modulated illuminating signals as modified in accordance with a plurality of different FCS's to the illumination source or other intended recipient. The system may include a plurality of BCD's, where each BCD is configured to re-modulate the illuminating signal with message data, modify the re-modulated illuminating signal in accordance with a different FCS, and re-transmit the modified and re-modulated illuminating signal. The BCD may be configured to identify itself to the illumination source or other intended recipient by re-modulating the illuminating waveforms of a frame into a particular sequence of alternative waveforms and further modifying the frame with a particular FCS.

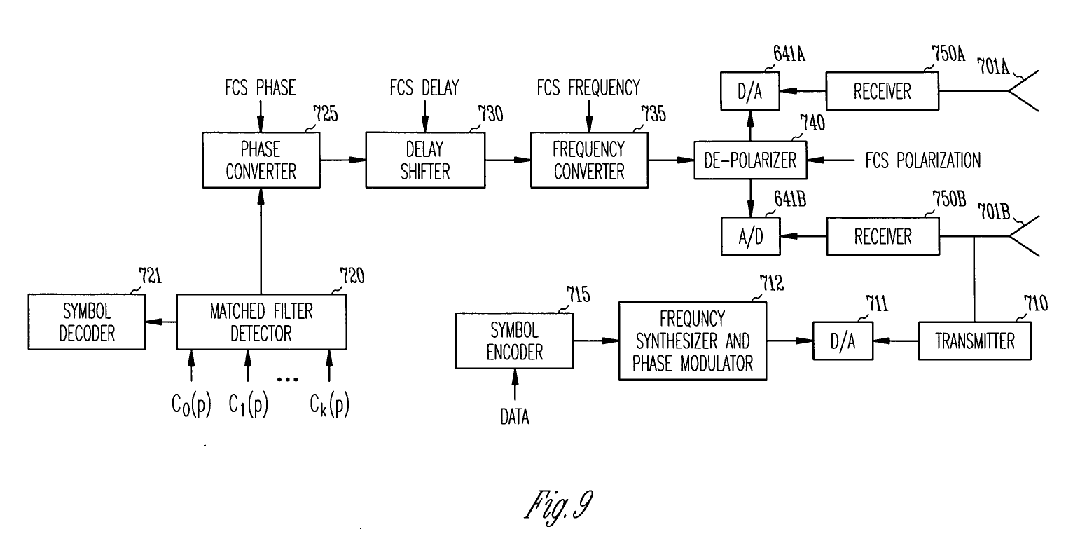

A particular exemplary embodiment of a system for backscatter communications is illustrated by FIGS. 8 and 9. FIG. 8 is a functional block diagram of the basic components of the BCD for this embodiment. The BCD is equipped with two antennas 601a and 601b (e.g., dipole antennas) that are orthogonally oriented to one another and coupled to transmitters 650a and 650b, respectively. As described below, the separate signals generated by each of transmitters 650a and 650b enable the BCD to output a backscattered and re-modulated illuminating waveform with any desired polarization state. Also coupled to one or both of the antennas is a receiver 610 for receiving the illuminating waveforms from the illumination source, shown in the figure as being coupled to antenna 601b. A directional coupler (not shown) may be used to isolate the transmitter 601b from the receiver 610. After filtering and amplification of the illuminating signal by receiver 610, the signal is sampled and digitized by analog-to-digital converter 611. If the illuminating signal is a communications signal, the resulting samples may be demodulated according to a specified modulation scheme (e.g., phase modulation) by demodulator 612 and input to symbol detector and decoder 613 in order to extract the communicated data. This allows the illumination source to send data to the BCD. Data intended to be transmitted from the BCD to the illumination source (or other intended recipient) is input to symbol encoder 615. The illuminating signal samples from A/D converter 611 are input to phase re-modulator 620 which phase modulates the samples in accordance with the symbols generated by the symbol encoder 615 to generate one of a finite set of alternative waveforms C₀(p) through Cₖ(p) that serve as communication symbols. The resulting re-modulated illuminating waveform is next synchronously modified as to phase, time delay, and frequency in accordance with the FCS for that particular waveform in the frame by phase converter 625, delay shifter 630, and frequency converter 635, respectively. The samples are then input to polarizer 640 which generates separate sample sequences in accordance with the polarization state specified by the FCS. The two outputs of polarizer 640 are converted to analog form by digital-to-analog converters 641a and 641b and fed to transmitters 650a and 650b which then drive the antennas 601a and 601b. The antennas 601a and 601b thus radiate a backscattered illuminating signal in which is embedded a communications signal generated by the BCD and that varies as to phase, time delay, frequency, and polarization according to a specified FCS.

FIG. 9 is a functional block diagram of the basic components of an exemplary illumination source that also serves as the intended recipient for communications from the BCD. The backscattered illuminating signal is received by orthogonally oriented antennas 701a and 701b which are coupled to receivers 750a and 750b, respectively. The received signals from each antenna are filtered and amplified by the receivers and converted to digital form by digital-to-analog converters 641a and 641b. The samples generated from the signals received by each orthogonally oriented antenna are then input to de-polarizer 740 which forms a composite signal in accordance with the polarization state as specified by the FCS for that particular waveform in the frame. The resulting signal is then modified as to frequency, time delay, and frequency in accordance with the FCS by frequency converter 735, delay shifter 730, and phase converter 725 to essentially reverse the operations performed on the illuminating waveform by the BCD. The resulting signal is then fed to matched filter detector 720 which correlates the signal with all of the possible alternative waveforms C₀(p) through Cₖ(p) and detects the symbol most likely to be present. Data is then extracted by symbol decoder 721.

The illuminating signal transmitted to the BCD may or may not constitute a communications signal. For the latter case, the illumination source may incorporate functionality for transmitting data to the BCD, such as is shown in FIG. 9. Data transmitted to the BCD could be used, for example, to synchronize the BCD to the illumination source when employing continuous or non-pulsed illuminating signals. Data to be transmitted from the illumination source is encoded into symbols by symbol encoder 715 which are used by frequency synthesizer and phase modulator 712 to generate a carrier signal that is phase modulated with the data. The resulting phase modulated signal is then converted to analog form by digital-to-analog converter 711 for driving the transmitter 710. The transmitter 710 is coupled to one or both of the antennas 701a and 701b, where a directional coupler may be used to isolate the transmitter from the receivers.

The invention has been described in conjunction with the foregoing specific embodiments. It should be appreciated that those embodiments may also be combined in any manner considered to be advantageous. Also, many alternatives, variations, and modifications will be apparent to those of ordinary skill in the art. Other such alternatives, variations, and modifications are intended to fall within the scope of the following appended claims.

What is claimed is:

1. A system, comprising:
an illumination source configured to radiate an illuminating signal;
a backscatter communication device (BCD) configured to re-modulate the illuminating signal received from the illumination source with message data;
wherein the BCD is configured to further modify the re-modulated illuminating signal so that the re-modulated illuminating waveform varies as to a plurality of frame coding parameters within defined time frames as specified by a defined frame coding scheme (FCS), where the plurality of frame coding parameters is selected from a group that includes frequency, time delay, and phase;
wherein the BCD is configured to re-transmit the re-modulated illuminating signal as modified in accordance with the FCS to the illumination source or other intended recipient; and,
wherein the illumination source or other intended recipient is configured to receive the re-transmitted signal from the BCD, synchronously reverse the modifications made to the re-transmitted signal by the BCD according to the FCS for each received frame of the re-transmitted signal, and demodulate the re-transmitted signal to extract the message data therefrom.

2. The system of claim 1 wherein the group of frame coding parameters further includes polarization such that the frame coding scheme (FCS) specifies a variation in polarization within each time frame, which variation in polarization is imparted by the BCD to the re-modulated illuminating signal that is re-transmitted and synchronously reversed by the illumination source or other intended recipient.

3. The system of claim 1 wherein the BCD is further configured to re-modulate each of one or more discrete segments of the illuminating signal within each time frame, referred to as illuminating waveforms, into one of a finite set of alternative waveforms that serve as communication symbols.

4. The system of claim 3 wherein the illumination source or other intended recipient is configured to synchronously detect the alternative waveforms from the re-transmitted illuminating signal by correlating the re-transmitted illuminating signal with the finite set of alternative waveforms after reversal of the FCS modifications.

5. The system of claim 4 wherein the illumination source or other intended recipient is configured to synchronously detect the alternative waveforms from the re-transmitted illuminating signal by correlating each illuminating waveform of the re-transmitted illuminating signal with the finite set of alternative waveforms.

6. The system of claim 4 wherein the illumination source or other intended recipient is configured to synchronously detect the alternative waveforms from the re-transmitted illuminating signal by correlating each frame of the re-transmitted illuminating signal with sequences of the finite set of alternative waveforms to thereby detect a particular sequence of alternative waveforms that serve as a communications symbol.

7. The system of claim 3 wherein the FCS specifies modifications as to frequency, time delay, and phase for each illuminating waveform within a frame.

8. The system of claim 1 wherein the BCD is further configured to simultaneously re-transmit a plurality of re-modulated illuminating signals as modified in accordance with a plurality of different FCS's to the illumination source or other intended recipient.

9. The system of claim 1 further comprising a plurality of BCD's, wherein each BCD is configured to re-modulate the illuminating signal with message data, modify the re-modulated illuminating signal in accordance with a different FCS, and re-transmit the modified and re-modulated illuminating signal.

10. The system of claim 3 wherein the BCD is configured to identify itself to the illumination source or other intended recipient by re-modulating the illuminating waveforms of a frame into a particular sequence of alternative waveforms and further modifying the frame with a particular FCS.

11. A method, comprising:
radiating an illuminating signal from an illumination source;
re-modulating the illuminating signal received from the illumination source at a backscatter communication device (BCD) with message data;
further modifying the re-modulated illuminating signal so that the re-modulated illuminating waveform varies as to a plurality of frame coding parameters within defined time frames as specified by a defined frame coding scheme (FCS), where the plurality of frame coding parameters is selected from a group that includes frequency, time delay, and phase;
re-transmitting the re-modulated illuminating signal as modified in accordance with the FCS to the illumination source or other intended recipient; and,
receiving the re-transmitted signal from the BCD, synchronously reversing the modifications made to the re-transmitted signal by the BCD according to the FCS for each received frame of the re-transmitted signal, and demodulating the re-transmitted signal to extract the message data therefrom.

12. The method of claim 11 wherein the group of frame coding parameters further includes polarization such that the frame coding scheme (FCS) specifies a variation in polarization within each time frame, which variation in polarization is imparted by the BCD to the re-modulated illuminating signal that is re-transmitted and synchronously reversed by the illumination source or other intended recipient.

13. The method of claim 11 further comprising re-modulating each of one or more discrete segments of the illuminating signal within each time frame, referred to as illuminating waveforms, into one of a finite set of alternative waveforms that serve as communication symbols.

14. The method of claim 13 further comprising synchronously detecting the alternative waveforms from the re-transmitted illuminating signal by correlating the re-transmitted illuminating signal with the finite set of alternative waveforms after reversal of the FCS modifications.

15. The method of claim 14 further comprising synchronously detecting the alternative waveforms from the re-transmitted illuminating signal by correlating each illuminating waveform of the re-transmitted illuminating signal with the finite set of alternative waveforms.

16. The method of claim 4 further comprising synchronously detecting the alternative waveforms from the re-transmitted illuminating signal by correlating each frame of the re-transmitted illuminating signal with sequences of the finite set of alternative waveforms to thereby detect a particular sequence of alternative waveforms that serve as a communications symbol.

17. The method of claim 13 wherein the FCS specifies modifications as to frequency, time delay, and phase for each illuminating waveform within a frame.

18. The method of claim 11 further comprising simultaneously re-transmitting a plurality of re-modulated illuminating signals as modified in accordance with a plurality of different FCS's to the illumination source or other intended recipient.

19. The method of claim 11 further comprising re-modulating the illuminating signal with message data at a plurality of BCD's, modifying the re-modulated illuminating signal in accordance with a different FCS for each BCD, and re-transmitting the modified and re-modulated illuminating signal.

20. The method of claim 13 further comprising identifying the BCD to the illumination source or other intended recipient by re-modulating the illuminating waveforms of a frame into a particular sequence of alternative waveforms and further modifying the frame with a particular FCS.
